(19) United States
(12) Patent Application Publication
(10) Pub. No.: US 2025/0240690 A1
(43) Pub. Date: Jul. 24, 2025

(54) PAGING METHOD AND APPARATUS, ELECTRONIC DEVICE, AND STORAGE MEDIUM

(71) Applicant: VIVO MOBILE COMMUNICATION CO., LTD., Dongguan (CN)

(72) Inventor: Shanshan GUO, Dongguan (CN)

(73) Assignee: VIVO MOBILE COMMUNICATION CO., LTD., Dongguan (CN)

(21) Appl. No.: 19/174,909

(22) Filed: Apr. 9, 2025

Related U.S. Application Data
(63) Continuation of application No. PCT/CN2023/123770, filed on Oct. 10, 2023.

(30) Foreign Application Priority Data
Oct. 11, 2022 (CN) 202211241402.1

(51) Int. Cl. H04W 36/14; H04L 65/1016; H04W 60/04; H04W 76/30

(52) U.S. Cl. CPC H04W 36/142; H04L 65/1016; H04W 60/04; H04W 76/30

(57) ABSTRACT

A paging method and apparatus, an electronic device, and a storage medium, are provided. The method includes: detecting whether a data radio bearer DRB that is of a first network and for transmitting Internet protocol multimedia subsystem IMS data has been established; when the DRB that is of the first network and for transmitting the IMS data has been established, switching from the first network to a second network when incoming call information is not received within a first preset duration through the DRB that is of the first network and for transmitting the IMS data; and when the DRB that is of the first network and for transmitting the IMS data has not been established, actively releasing the first network and sending a mobility registration update request of the first network to a network side device, or performing a cell switching process.

### CROSS-REFERENCE TO RELATED APPLICATIONS

This application is a continuation of International Application No. PCT/CN2023/123770, filed on Oct. 10, 2023, which claims priority to Chinese Patent Application No. 202211241402.1, filed Oct. 11, 2022. The entire contents of each of the above-referenced applications are expressly incorporated herein by reference.

### TECHNICAL FIELD

This application belongs to the field of communication technologies, and specifically, relates to a paging method and apparatus, an electronic device, and a storage medium.

### BACKGROUND

The 5th Generation Mobile Communication Technology (5G) provides a voice service based on an IP Multimedia Subsystem (IMS), and a voice call service borne on the 5G is referred to as a Voice over New Radio (VoNR) service, so that an electronic device can keep a stable and high-speed data connection during a call.

However, due to research and development time, existing VoNR networks have not actually reached a stable state of Voice over Long-Term Evolution (VoLTE). In addition, due to various network problems such as network failures or IMS link abnormalities, VoNR voice cannot be answered normally, leading to a failure in answering a VoNR call.

### SUMMARY

An objective of embodiments of this application is to provide a paging method and apparatus, an electronic device, and a storage medium.

According to a first aspect, an embodiment of this application provides a paging method, the method including: detecting whether a data radio bearer DRB that is of a first network and for transmitting IMS data has been established; in a case that the DRB that is of the first network and for transmitting the IMS data has been established, switching from the first network to a second network if incoming call information is not received within a first preset duration through the DRB that is of the first network and for transmitting the IMS data; and in a case that the DRB that is of the first network and for transmitting the IMS data has not been established, actively releasing the first network and sending a mobility registration update request of the first network to a network side device, or performing a cell switching process, where the mobility registration update request is for requesting re-registration to the first network, the mobility registration update request includes target data, and the target data is used for indicating that an electronic device has data to be sent.

According to a second aspect, an embodiment of this application provides a paging apparatus, the paging apparatus including a detection module, a switching module, and a processing module, where the detection module is configured to detect whether a data radio bearer DRB that is of a first network and for transmitting IMS data has been established; the switching module is configured to: in a case that the DRB that is of the first network and for transmitting the IMS data has been established, switch from the first network to a second network if incoming call information is not received within a first preset duration through the DRB that is of the first network and for transmitting the IMS data; and the processing module is configured to: in a case that the DRB that is of the first network and for transmitting the IMS data has not been established, actively release the first network and send a mobility registration update request of the first network to a network side device, or perform a cell switching process, where the mobility registration update request is for requesting re-registration to the first network, the mobility registration update request includes target data, and the target data is used for indicating that an electronic device has data to be sent.

According to a third aspect, an embodiment of this application provides an electronic device. The electronic device includes a processor and a memory, the memory stores a program or an instruction executable on the processor, and when the program or the instruction is executed by the processor, the steps of the method according to the first aspect are implemented.

According to a fourth aspect, an embodiment of this application provides a readable storage medium, storing a program or an instruction, where when the program or the instruction is executed by a processor, the steps of the method according to the first aspect are implemented.

According to a fifth aspect, an embodiment of this application provides a chip, including a processor and a communication interface, where the communication interface is coupled to the processor, and the processor is configured to execute a program or an instruction, to implement the method according to the first aspect.

According to a sixth aspect, an embodiment of this application provides a computer program product, where the program product is stored in a storage medium, and the program product is executed by at least one processor to implement the method according to the first aspect.

In the embodiments of this application, the electronic device may detect whether the DRB that is of the first network and for transmitting the IMS data has been established, and in a case that the DRB that is of the first network and for transmitting the IMS data has been established, the electronic device switches from the first network to the second network if the incoming call information is not received within the first preset duration through the DRB that is of the first network and for transmitting the IMS data; and in a case that the DRB that is of the first network and for transmitting the IMS data has not been established, the electronic device may actively release the first network and send the mobility registration update request of the first network to the network side device, where the mobility registration update request includes the target data, and the target data is used for indicating that the electronic device has data to be sent; or perform a cell switching process. In this solution, the electronic device may detect whether the DRB that is of the first network and for transmitting the IMS data has been established, so that when the electronic device detects that the DRB that is of the first network and for transmitting the IMS data has been established and the incoming call information is not received within the first preset duration through the DRB that is of the first network and for transmitting the IMS data, the electronic device may determine that a current network is abnormal, and switch from the first network to the second network to receive the incoming call information. In some implementations, when the electronic device detects that the DRB that is of the first network and for transmitting the IMS data has not been established, the electronic device may actively release the first network and send the mobility registration update request of the first network to the network side device, to re-register to the first network. In addition, the mobility registration update request includes the target data indicating that the electronic device has data to be sent, so that the network side device may be induced to re-establish the DRB that is of the first network and for transmitting the IMS data to receive the incoming call information. In some implementations, when the electronic device detects that the DRB that is of the first network and for transmitting the IMS data has not been established, the electronic device may determine that the source cell in the first network is abnormal and perform a cell switching process, to receive the incoming call information through the DRB that is of the first network and for transmitting the IMS data that is established in a cell after the switching. That is, the electronic device may perform a corresponding operation through a detected establishment result of the DRB that is of the first network and for transmitting the IMS data, so that VoNR voice can be answered normally.

### BRIEF DESCRIPTION OF THE DRAWINGS

FIG. 1 is a first flowchart of a paging method according to an embodiment of this application;

FIG. 2 is a second flowchart of a paging method according to an embodiment of this application;

FIG. 3 is a third flowchart of a paging method according to an embodiment of this application;

FIG. 4 is a block diagram of a paging apparatus according to an embodiment of this application;

FIG. 5 is a first block diagram of hardware of an electronic device according to an embodiment of this application; and

FIG. 6 is a second block diagram of hardware of an electronic device according to an embodiment of this application.

### DETAILED DESCRIPTION

The following describes the embodiments of this application with reference to the accompanying drawings in the embodiments of this application. Apparently, the described embodiments are some of the embodiments of this application rather than all of the embodiments. All other embodiments obtained by a person of ordinary skill in the art based on the embodiments of this application all fall within the protection scope of this application.

The specification and claims of this application, and terms such as “first” and “second” are used to distinguish similar objects, but are unnecessarily used to describe a specific sequence or order. It may be understood that the terms used in such a way is interchangeable in proper circumstances, so that the embodiments of this application can be implemented in other sequences than the sequence illustrated or described herein. In addition, the objects distinguished by “first” and “second” are generally of a same type, and a quantity of the objects is not limited. For example, a first object may be one object or may be a plurality of objects. In addition, “and/or” used in this specification and the claims represents at least one of the connected objects, and the character “/” generally indicates an “or” relationship between the associated objects.

The following describes a paging method provided in the embodiments of this application in detail with reference to the accompanying drawings and through specific embodiments and application scenarios thereof.

The paging method in the embodiments of this application may be applied to a scenario in which an electronic device answers an incoming call.

A radio access part of 5G is called as New Radio (NR), and a 5G-based voice service is called as VoNR. That is, an NR user can directly perform a voice service based on an NR network without falling back to a Long Term Evolution (LTE) network, to obtain voice service experience with better quality and data service experience with a higher rate. Before the VoNR technology is applied, when a voice call is performed, a resident network of a mobile phone will fall back from 5G to 4G. However, the VoNR technology supports concurrency of 5G data and voice, so that using the VoNR technology can not only reduce time for establishing a phone call connection, but also can reduce an interruption that may exist during a call while a connection success rate is greatly improved. In addition, the VoNR technology can further keep a stable and high-speed 5G data connection during a call, so that game and video experience is not affected. At present, major manufacturers are all accelerating plans for supporting VoNR functions in electronic devices, and operators have basically covered VoNR networks and are gradually completing commercialization of VoNR. In this way, further improving a VoNR voice service capability becomes increasingly important.

However, due to research and development time, existing VoNR networks have not actually reached a stable state like VoLTE, and due to various network problems, VoNR voice call failures and answering failures may be caused, affecting successful establishment of a VoNR call. The establishment of the VoNR call requires a network side device to configure a Data Radio Bearer (DRB) for transmitting IMS data. However, due to various reasons, the network side device may not configure the DRB for the electronic device, for example, states of the electronic device and the network are not synchronized, an IMS link is abnormal, or a network failure occurs, and the electronic device has no DRB available. As a result, the electronic device cannot successfully receive incoming call information. In addition, although the electronic device has DRBs available, an abnormality may occur in the network, and a request message is not forwarded in time. As a result, the electronic device cannot receive the incoming call information.

In the solutions provided in the embodiments of this application, the electronic device may detect whether a DRB that is of a first network and for transmitting IMS data has been established, and in a case that the DRB that is of the first network and for transmitting the IMS data has been established, the electronic device switches from the first network to a second network if incoming call information is not received within a first preset duration through the DRB that is of the first network and for transmitting the IMS data; and in a case that the DRB that is of the first network and for transmitting the IMS data has not been established, the electronic device may actively release the first network and send a mobility registration update request of the first network to the network side device, where the mobility registration update request includes target data, and the target data is used for indicating that the electronic device has data to be sent; or perform a cell switching process. In this solution, the electronic device may detect whether the DRB that is of the first network and for transmitting the IMS data has been established, so that when the electronic device detects that the DRB that is of the first network and for transmitting the IMS data has been established and the incoming call information is not received within the first preset duration through the DRB that is of the first network and for transmitting the IMS data, the electronic device may determine that a current network is abnormal, and switch from the first network to the second network to receive the incoming call information. In some implementations, when the electronic device detects that the DRB that is of the first network and for transmitting the IMS data has not been established, the electronic device may actively release the first network and send the mobility registration update request of the first network to the network side device, to re-register to the first network. In addition, the mobility registration update request includes the target data indicating that the electronic device has data to be sent, so that the network side device may be induced to re-establish the DRB that is of the first network and for transmitting the IMS data to receive the incoming call information. In some implementations, when the electronic device detects that the DRB that is of the first network and for transmitting the IMS data has not been established, the electronic device may determine that a source cell in the first network is abnormal and perform a cell switching process, to receive the incoming call information through the DRB that is of the first network and for transmitting the IMS data that is established in a cell after the switching. That is, the electronic device may perform a corresponding operation through a detected establishment result of the DRB that is of the first network and for transmitting the IMS data, so that VoNR voice can be answered normally.

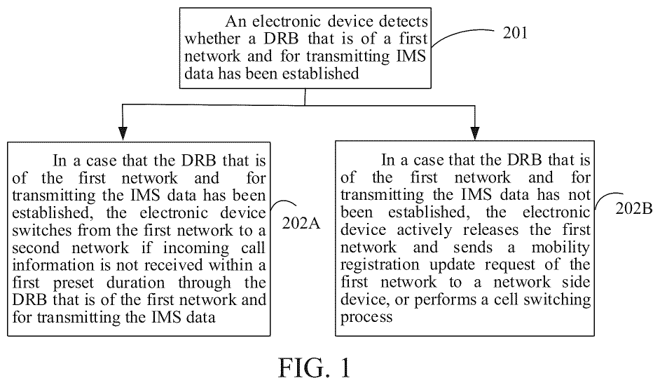

An embodiment of this application provides a paging method. FIG. 1 is a flowchart of a paging method according to an embodiment of this application, and the method may be applied to an electronic device. As shown in FIG. 1, the paging method provided in the embodiments of this application may include the following step 201 and step 202A or the following step 201 and step 202B.

Step 201. The electronic device detects whether a DRB that is of a first network and for transmitting IMS data has been established.

In some implementations, the first network may be an NR network.

In some implementations, the DRB for transmitting the IMS data may be established/configured through a Radio Resource Control (RRC) reconfiguration message delivered by a network side device.

Step 202A. In a case that the DRB that is of the first network and for transmitting the IMS data has been established, the electronic device switches from the first network to a second network if incoming call information is not received within a first preset duration through the DRB that is of the first network and for transmitting the IMS data.

In some implementations, the second network may be an LTE network.

It may be understood that, when the DRB that is of the first network and for transmitting the IMS data has been established but the incoming call information is not received within the first preset duration through the DRB that is of the first network and for transmitting the IMS data, the electronic device may determine that a current network is abnormal, and switch from the first network to the second network to receive an incoming call.

In some implementations, time that the electronic device waits for paging is generally about 20 s, so that the first preset duration may be set to 20 seconds. A specific value may be adjusted according to an actual situation, which is not limited in the embodiments of this application.

In some implementations, the first preset duration may be a minimum threshold that the electronic device can reside in the first network and wait for receiving the incoming call information.

In some implementations, the step “switch from the first network to a second network if incoming call information is not received within a first preset duration through the DRB that is of the first network and for transmitting the IMS data” in step 202A specifically may be implemented through the following step A11 and step A12.

Step A11. The electronic device starts a first timer, and starts to detect whether the incoming call information is received through the DRB that is of the first network and for transmitting the IMS data.

In the embodiments of this application, when it is detected that the DRB that is of the first network and for transmitting the IMS data has been established, the electronic device may start the first timer, and detect whether the incoming call information is received through the DRB that is of the first network and for transmitting the IMS data within a start duration of the first timer.

Step A12. The electronic device switches from the first network to the second network in a case that the first timer expires and it is detected that the incoming call information is not received through the DRB that is of the first network and for transmitting the IMS data.

In the embodiments of this application, that the first timer expires means that the start duration of the first timer exceeds the first preset duration.

It may be understood that, in a case that the first timer expires and the electronic device does not receive the incoming call information, the electronic device may determine that the current network is abnormal and the incoming call information cannot be received consequently, so that the electronic device may actively switch to the second network to receive the incoming call.

In some implementations, after the foregoing step A12, the paging method provided in the embodiments of this application further includes the following step B11 and step B12 or the following step B11 and step B13.

Step B11. The electronic device starts a second timer, and starts to detect whether the incoming call information is received through the second network.

It may be understood that, after switching to the second network, the electronic device may start the second timer, and detect whether the incoming call information is received through the second network within a start duration of the second timer.

Step B12. In a case that the second timer does not expire and it is detected that the incoming call information is received through the second network, the electronic device answers an incoming call through the second network, and switches from the second network to the first network after the incoming call ends.

In the embodiments of this application, that the second timer does not expire means that the start duration of the second timer does not exceed a second preset duration.

It may be understood that, if the electronic device receives the incoming call information within the start duration of the second timer, it is considered that falling back to the second network for receiving the incoming call information takes effect, and the electronic device may actively return to the first network after the call ends.

In this way, when the electronic device has high requirements on a data transmission rate and network quality and needs to reside in a high-standard network (that is, the first network) to provide a smoother service for a user, influence on normal operation of the electronic device can be avoided.

In some implementations, the second preset duration may be a maximum threshold that the electronic device can reside in the second network and wait for receiving the incoming call information.

In some implementations, time that the electronic device is automatically hung up since ringtone information is not received from a call is initiated is generally about 60 seconds, so that a total duration of the first preset duration and the second preset duration may be set to 60 seconds. A specific value may be adjusted according to an actual situation, which is not limited in the embodiments of this application.

In some implementations, the electronic device may close the second timer after receiving the incoming call information, and actively return to the first network after the call ends.

In some implementations, the incoming call information received by the electronic device may be a paging message (Paging) or an INVITE message in an IMS domain.

Step B13. In a case that the second timer expires and it is detected that the incoming call information is not received through the second network, the electronic device switches from the second network to the first network, and re-registers to a cell different from a source cell in the first network.

In the embodiments of this application, that the second timer expires means that a start duration of the second timer exceeds a second preset duration.

It may be understood that, after switching to the second network, the electronic device may start the second timer, and detect whether the electronic device receives the incoming call information through the second network within the start duration of the second timer. If the electronic device does not receive the incoming call information through the second network within the start duration of the second timer, it is considered that falling back to the second network for receiving the incoming call information does not take effect, and the electronic device actively returns to the first network after the second timer expires. In addition, when the electronic device resides in the first network, the electronic device determines that the current network is abnormal and the incoming call information cannot be received consequently. Therefore, to avoid the problem of a failure in receiving the incoming call information due to an abnormal network, the electronic device may re-register to a cell different from the source cell in the first network after returning to the first network.

In some implementations, the electronic device may re-register to a cell different from the source cell in the first network according to a comprehensive rank of cells.

In some implementations, the electronic device answers an incoming call through the first network in a case that the first timer does not expire and it is detected the incoming call information is received through the DRB that is of the first network and for transmitting the IMS data.

In the embodiments of this application, that the first timer does not expire means that the start duration of the first timer does not exceed the first preset duration.

In some implementations, when the first timer does not expire and the electronic device receives the incoming call information through the DRB that is of the first network and for transmitting the IMS data, the electronic device may close the first timer and answer the incoming call through the first network.

Step 202B. In a case that the DRB that is of the first network and for transmitting the IMS data has not been established, the electronic device actively releases the first network and sends a mobility registration update request of the first network to a network side device, or performs a cell switching process.

In the embodiments of this application, the mobility registration update request is for requesting re-registration to the first network, the mobility registration update request includes target data, and the target data is used for indicating that the electronic device has data to be sent.

In some implementations, the target data may be data of the electronic device for inducing the network side device to re-establish the DRB that is of the first network and for transmitting the IMS data, that is, the electronic device does not have data to be sent, or the target data may be data of the electronic device that needs to be sent, for example, data to be sent after the electronic device receives a paging message forwarded by the first network.

In some implementations, the electronic device may actively perform a local release (local release) to disconnect a radio resource control RRC connection of the first network and enter an idle state.

It may be understood that, the electronic device may carry the target data in the mobility registration update request, to notify the network side device that the electronic device needs to send the IMS data, so that the network side device re-establishes the DRB that is of the first network and for transmitting the IMS data.

It may be understood that, in a case that the DRB that is of the first network and for transmitting the IMS data has not been established, the electronic device cannot receive paging (Paging) in the idle state and cannot receive a paging request (INVITE) in a connected state.

In some implementations, after the step “the electronic device actively releases the first network and sends a mobility registration update request of the first network to a network side device” in the foregoing step 202B, the paging method provided in the embodiments of this application further includes the following step C1.

Step C1. The electronic device receives a mobility registration update response sent by the network side device.

In the embodiments of this application, the mobility registration update response is used for indicating that the network side device re-establishes the DRB that is of the first network and for transmitting the IMS data, and the DRB that is of the first network and for transmitting the IMS data is used by the electronic device to receive the incoming call information.

It may be understood that, after the network side device receives the mobility registration update request sent by the electronic device, since the mobility registration update request carries the target data, the network side device may determine that the electronic device needs to send data, so that the network side device may re-establish the DRB that is of the first network and for transmitting the IMS data, and send the mobility registration update response to the electronic device, to indicate that the network side device re-establishes the DRB that is of the first network and for transmitting the IMS data. Therefore, the electronic device may receive the incoming call information through the re-established DRB that is of the first network and for transmitting the IMS data.

In some implementations, the step “the electronic device performs a cell switching process” in the foregoing step 202B specifically may be implemented through the following step D1 and step D3.

Step D1. The electronic device measures signal quality of at least one neighboring cell of a source cell in the first network.

In the embodiments of this application, in a case that the DRB that is of the first network and for transmitting the IMS data has not been established, the electronic device may determine that the source cell in the first network is abnormal, perform cell switching by measuring the signal quality of the at least one neighboring cell of the source cell in the first network, to receive the incoming call information through the DRB that is of the first network and for transmitting the IMS data established in a new cell.

In some implementations, the at least one neighboring cell may include an intra-frequency neighboring cell and an inter-frequency neighboring cell.

Step D2. The electronic device switches from the source cell in the first network to a target cell in a case that a cell whose signal quality is greater than or equal to a preset threshold exists in the at least one neighboring cell.

In the embodiments of this application, the target cell is a cell with the greatest signal quality in the at least one neighboring cell.

In some implementations, in a case that a cell whose signal quality is greater than or equal to the preset threshold exists in the at least one neighboring cell, the electronic device may determine the cell with the greatest signal quality in neighboring cells whose signal quality is greater than or equal to the preset threshold as the target cell, and switch to the target cell.

For example, in a case that a cell whose signal quality is greater than or equal to −115 dbm exists in the at least one neighboring cell, the electronic device may determine a cell with the greatest signal quality in the cell whose signal quality is greater than or equal to −115 dbm as the target cell, and switch to the target cell.

In some implementations, the target cell may be an intra-frequency neighboring cell or an inter-frequency neighboring cell.

In some implementations, in a case that no cell whose signal quality is greater than or equal to the preset threshold exists in the at least one neighboring cell, the electronic device does not perform an operation.

In some implementations, the step “the electronic device switches from the source cell in the first network to a target cell” in the foregoing step D2 specifically may be implemented through the following step F1 and step F2.

Step F1. The electronic device reports a first measurement event to the network side device in a case that the target cell is an intra-frequency neighboring cell.

In the embodiments of this application, the first measurement event is used for indicating that the signal quality of the intra-frequency neighboring cell is greater than the signal quality of a serving cell.

In some implementations, the first measurement event may be an A3 event.

In some implementations, when the intra-frequency neighboring cell has the greatest signal quality and the signal quality of the intra-frequency neighboring cell is less than the signal quality of the serving cell, that is, a cell switching requirement is not met, the electronic device may ignore the A3 event configured by the network side device and actively report a first measurement event. That is, the electronic device may actively report a first measurement event meeting the requirement of switching to the intra-frequency neighboring cell, to switch to the intra-frequency neighboring cell.

For example, a signal strength of the intra-frequency neighboring cell is −100 dbm, and a threshold of the A3 event configured by the network side device is −97 dbm. In this case, the cell switching requirement that the signal quality of the neighboring cell is greater than the signal quality of the serving cell is not met. Therefore, the electronic device may ignore the A3 event configured by the network side device, configure an A3 event (for example, an A3 event whose event threshold is −103 dbm), and report the A3 event. It may be understood that, the signal quality of the neighboring cell is greater than the signal quality of the serving cell in this case, and switching to the intra-frequency neighboring cell can be triggered.

F2. The electronic device receives a switching indication message sent by the network side device, and switches from the source cell in the first network to the intra-frequency neighboring cell according to the switching indication message.

It may be understood that, after receiving the first measurement event reported by the electronic device and used for indicating that the signal quality of the intra-frequency neighboring cell is greater than the signal quality of the serving cell, the network side device may send the switching indication message to the electronic device, to indicate the electronic device to switch from the source cell in the first network to the intra-frequency neighboring cell.

In some implementations, the step “the electronic device switches from the source cell in the first network to a target cell” in the foregoing step D2 specifically may be implemented through the following step F3 and step F4.

Step F3. The electronic device reports a second measurement event to the network side device in a case that the target cell is an inter-frequency neighboring cell.

In the embodiments of this application, the second measurement event is used for indicating that the signal quality of a serving cell is less than a preset threshold.

In some implementations, the second measurement event may be an A2 event.

In some implementations, when the inter-frequency neighboring cell has the greatest signal quality and the signal quality of the serving cell is greater than the preset threshold, that is, conditions for the network side device to deliver a B2 event are not met, the electronic device may ignore the A2 event configured by the network side device, and actively report a second measurement event. That is, the electronic device may actively report a second measurement event indicating that the signal quality of the serving cell is less than the preset threshold, to induce the network side device to deliver a B2 event, so as to switch the inter-frequency neighboring cell.

For example, the preset threshold is −110 dbm, and a threshold of the A2 event configured by the network side device is −97 dbm. In this case, the signal quality of the serving cell is less than the preset threshold. Therefore, the electronic device may ignore the A2 event configured by the network side device, configure an A2 event (for example, an A2 event whose event threshold is −112 dbm), and report the A2 event. It may be understood that, the signal quality of the serving cell is less than the preset threshold in this case, and the network side device may be triggered to deliver a B2 event.

Step F4. The electronic device receives a third measurement event sent by the network side device, and switches from the source cell in the first network to the inter-frequency neighboring cell according to the third measurement event.

In the embodiments of this application, the third measurement event is used for indicating that the signal quality of the serving cell is less than the preset threshold and the signal quality of the inter-frequency neighboring cell is greater than the preset threshold.

In some implementations, the third measurement event may be a B2 event.

It may be understood that, after receiving the second measurement event reported by the electronic device and used for indicating that the signal quality of the serving cell is less than the preset threshold, the network side device may send the third measurement event to the electronic device, so that the electronic device may switch from the source cell in the first network to the inter-frequency neighboring cell according to the third measurement event.

Step D3. The electronic device receives the incoming call information through the DRB that is of the first network and for transmitting the IMS data.

In the embodiments of this application, the DRB that is of the first network and for transmitting the IMS data is established by the network side device in the target cell.

It may be understood that, after the electronic device switches from the source cell in the first network to the target cell, the network side device may establish the DRB that is of the first network and for transmitting the IMS data in the target cell, so that the electronic device may receive the incoming call information through the DRB that is of the first network and for transmitting the IMS data.

In this way, an abnormal cell may be prevented from affecting the electronic device in receiving the incoming call information.

According to the paging method provided in the embodiments of this application, the electronic device may detect whether the DRB that is of the first network and for transmitting the IMS data has been established, so that when the electronic device detects that the DRB that is of the first network and for transmitting the IMS data has been established and the incoming call information is not received within the first preset duration through the DRB that is of the first network and for transmitting the IMS data, the electronic device may determine that a current network is abnormal, and switch from the first network to the second network to receive the incoming call information. In some implementations, when the electronic device detects that the DRB that is of the first network and for transmitting the IMS data has not been established, the electronic device may actively release the first network and send the mobility registration update request of the first network to the network side device, to re-register to the first network. In addition, the mobility registration update request includes the target data indicating that the electronic device has data to be sent, so that the network side device may be induced to re-establish the DRB that is of the first network and for transmitting the IMS data to receive the incoming call information. In some implementations, when the electronic device detects that the DRB that is of the first network and for transmitting the IMS data has not been established, the electronic device may determine that the source cell in the first network is abnormal and perform a cell switching process, to receive the incoming call information through the DRB that is of the first network and for transmitting the IMS data that is established in a cell after the switching. That is, the electronic device may perform a corresponding operation through a detected establishment result of the DRB that is of the first network and for transmitting the IMS data, so that VoNR voice can be answered normally.

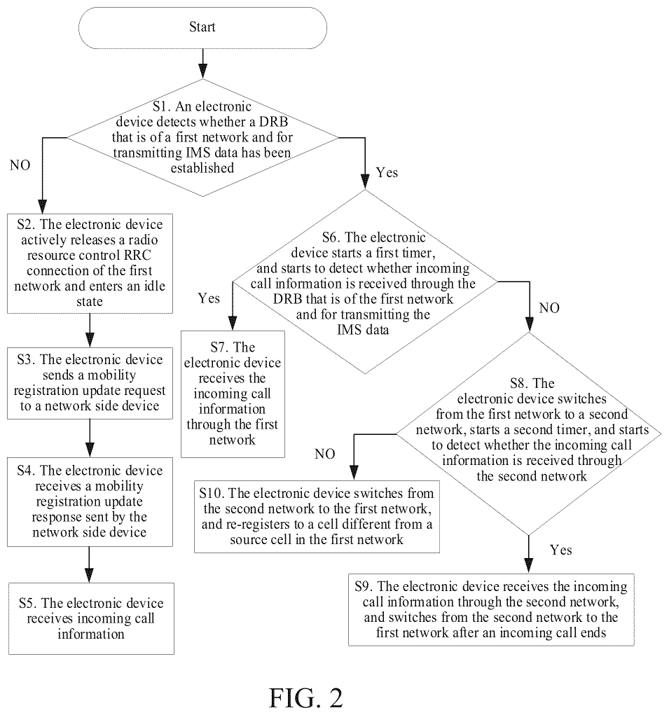

In the embodiments of this application, as shown in FIG. 2, the paging method provided in the embodiments of this application may include the following step S1 to step S10.

Step S1. An electronic device detects whether a DRB that is of a first network and for transmitting IMS data has been established.

Step S2. In a case of detecting that the DRB that is of the first network and for transmitting the IMS data has not been established, the electronic device actively releases a radio resource control RRC connection of the first network and enters an idle state.

Step S3. The electronic device sends a mobility registration update request to a network side device.

In the embodiments of this application, the mobility registration update request includes target data.

Step S4. The electronic device receives a mobility registration update response sent by the network side device.

In the embodiments of this application, the mobility registration update response is used for indicating that the network side device re-establishes the DRB that is of the first network and for transmitting the IMS data.

Step S5. The electronic device receives incoming call information.

Step S6. When the electronic device detects that the DRB that is of the first network and for transmitting the IMS data has been established, the electronic device starts a first timer, and starts to detect whether incoming call information is received through the DRB that is of the first network and for transmitting the IMS data.

Step S7. The electronic device receives the incoming call information through the first network.

Step S8. The electronic device does not receive the incoming call information through the first network, switches from the first network to a second network, starts a second timer, and starts to detect whether the incoming call information is received through the second network.

Step S9. The electronic device receives the incoming call information through the second network, and switches from the second network to the first network after an incoming call ends.

Step S10. The electronic device does not receive the incoming call information through the second network, switches from the second network to the first network, and re-registers to a cell different from a source cell in the first network.

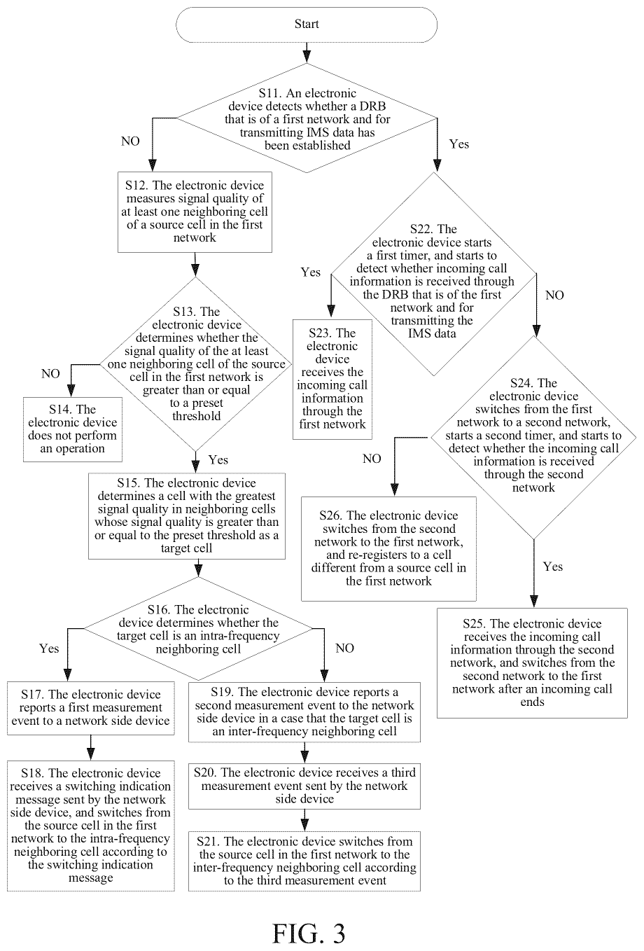

In the embodiments of this application, as shown in FIG. 3, the paging method provided in the embodiments of this application may include the following step S11 to step S26.

Step S11. An electronic device detects whether a DRB that is of a first network and for transmitting IMS data has been established.

Step S12. In a case of detecting that the DRB that is of the first network and for transmitting the IMS data has not been established, the electronic device measures signal quality of at least one neighboring cell of a source cell in the first network.

Step S13. The electronic device determines whether the signal quality of the at least one neighboring cell of the source cell in the first network is greater than or equal to a preset threshold.

Step S14. In a case that the signal quality of the at least one neighboring cell is not greater than or equal to the preset threshold, the electronic device does not perform an operation.

Step S15. In a case that a cell whose signal quality is greater than or equal to the preset threshold exists in the at least one neighboring cell, the electronic device determines a cell with the greatest signal quality in neighboring cells whose signal quality is greater than or equal to the preset threshold as a target cell.

Step S16. The electronic device determines whether the target cell is an intra-frequency neighboring cell.

Step S17. The electronic device reports a first measurement event to a network side device in a case that the target cell is an intra-frequency neighboring cell.

S18. The electronic device receives a switching indication message sent by the network side device, and switches from the source cell in the first network to the intra-frequency neighboring cell according to the switching indication message.

Step S19. The electronic device reports a second measurement event to the network side device in a case that the target cell is an inter-frequency neighboring cell.

Step S20. The electronic device receives a third measurement event sent by the network side device.

Step S21. The electronic device switches from the source cell in the first network to the inter-frequency neighboring cell according to the third measurement event.

Step S22 to step S26 are the same as the foregoing step S6 to step S10.

It should be noted that, a body executing the paging method provided in the embodiments of this application may be a paging apparatus. An example in which the paging apparatus performs the paging method is used in the embodiments of this application to describe the paging apparatus provided in the embodiments of this application.

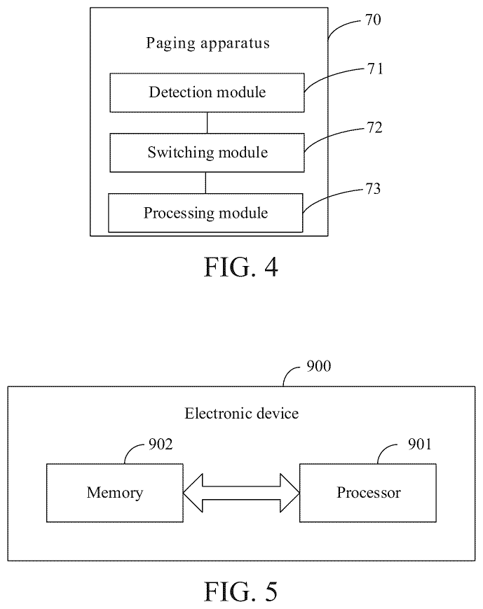

FIG. 4 is a schematic diagram of a structure of a paging apparatus involved in the embodiments of this application. As shown in FIG. 4, the paging apparatus 70 may include: a detection module 71, a switching module 72, and a processing module 73.

The detection module 71 is configured to detect whether a data radio bearer DRB that is of a first network and for transmitting IMS data has been established. The switching module 72 is configured to: in a case that the DRB that is of the first network and for transmitting the IMS data has been established, switch from the first network to a second network if incoming call information is not received within a first preset duration through the DRB that is of the first network and for transmitting the IMS data. The processing module 73 is configured to: in a case that the DRB that is of the first network and for transmitting the IMS data has not been established, actively release the first network and send a mobility registration update request of the first network to a network side device, or perform a cell switching process, where the mobility registration update request is for requesting re-registration to the first network, the mobility registration update request includes target data, and the target data is used for indicating that an electronic device has data to be sent.

According to the paging apparatus provided in the embodiments of this application, the paging apparatus may detect whether the DRB that is of the first network and for transmitting the IMS data has been established, so that when the paging apparatus detects that the DRB that is of the first network and for transmitting the IMS data has been established and the incoming call information is not received within the first preset duration through the DRB that is of the first network and for transmitting the IMS data, the paging apparatus may determine that a current network is abnormal, and switch from the first network to the second network to receive the incoming call information. In some implementations, when the paging apparatus detects that the DRB that is of the first network and for transmitting the IMS data has not been established, the paging apparatus may actively release the first network and send the mobility registration update request of the first network to the network side device, to re-register to the first network. In addition, the mobility registration update request includes the target data indicating that the paging apparatus has data to be sent, so that the network side device may be induced to re-establish the DRB that is of the first network and for transmitting the IMS data to receive the incoming call information. In some implementations, when the paging apparatus detects that the DRB that is of the first network and for transmitting the IMS data has not been established, the paging apparatus may determine that a source cell in the first network is abnormal and perform a cell switching process, to receive the incoming call information through the DRB that is of the first network and for transmitting the IMS data that is established in a cell after the switching. That is, the paging apparatus may perform a corresponding operation through a detected establishment result of the DRB that is of the first network and for transmitting the IMS data, so that VoNR voice can be answered normally.

In some implementations, the switching module 72 is specifically configured to: start a first timer, and start to detect whether the incoming call information is received through the DRB that is of the first network and for transmitting the IMS data; and switch from the first network to the second network in a case that the first timer expires and it is detected that the incoming call information is not received through the DRB that is of the first network and for transmitting the IMS data, where that the first timer expires means that a start duration of the first timer exceeds the first preset duration.

In some implementations, the processing module 73 is further configured to: start a second timer, and start to detect whether the incoming call information is received through the second network after the switching module 72 switches from the first network to the second network; and in a case that the second timer does not expire and it is detected that the incoming call information is received through the second network, answer an incoming call through the second network, and switch from the second network to the first network after the incoming call ends, where that the second timer does not expire means that a start duration of the second timer does not exceed a second preset duration; or in a case that the second timer expires and it is detected that the incoming call information is not received through the second network, switch from the second network to the first network, and re-register to a cell different from a source cell in the first network, where that the second timer expires means that a start duration of the second timer exceeds a second preset duration.

In some implementations, the paging apparatus 70 provided in the embodiments of this application further includes: a receiving module. The receiving module is configured to receive a mobility registration update response sent by the network side device after the processing module 73 actively releases the first network and sends the mobility registration update request of the first network to the network side device, where the mobility registration update response is used for indicating that the network side device re-establishes the DRB that is of the first network and for transmitting the IMS data, and the DRB that is of the first network and for transmitting the IMS data is used by the electronic device to receive the incoming call information.

In some implementations, the processing module 73 is specifically configured to: measure signal quality of at least one neighboring cell of a source cell in the first network; switch from the source cell in the first network to a target cell in a case that a cell whose signal quality is greater than or equal to a preset threshold exists in the at least one neighboring cell, where the target cell is a cell with the greatest signal quality in the at least one neighboring cell; and receive the incoming call information through the DRB that is of the first network and for transmitting the IMS data, where the DRB that is of the first network and for transmitting the IMS data is established by the network side device in the target cell.

In some implementations, the processing module 73 is specifically configured to: report a first measurement event to the network side device in a case that the target cell is an intra-frequency neighboring cell, where the first measurement event is used for indicating that the signal quality of the intra-frequency neighboring cell is greater than the signal quality of a serving cell; and receive a switching indication message sent by the network side device, and switch from the source cell in the first network to the intra-frequency neighboring cell according to the switching indication message.

In some implementations, the processing module 73 is specifically configured to: report a second measurement event to the network side device in a case that the target cell is an inter-frequency neighboring cell, where the second measurement event is used for indicating that the signal quality of a serving cell is less than a preset threshold; and receive a third measurement event sent by the network side device, and switch from the source cell in the first network to the inter-frequency neighboring cell according to the third measurement event, where the third measurement event is used for indicating that the signal quality of the serving cell is less than the preset threshold and the signal quality of the inter-frequency neighboring cell is greater than the preset threshold.

The paging apparatus in the embodiments of this application may be an electronic device or a component such as an integrated circuit or a chip in the electronic device. The electronic device may be a terminal, or may be another device other than the terminal. For example, the electronic device may be a mobile phone, a tablet computer, a notebook computer, a palmtop computer, an in-vehicle electronic device, a Mobile Internet Device (MID), an Augmented Reality (AR)/Virtual Reality (VR) device, a robot, a wearable device, an Ultra-Mobile Personal Computer (UMPC), a netbook, or a Personal Digital Assistant (PDA), or may be a server, a Network Attached Storage (NAS), a personal computer, a television, a teller machine, or a self-service machine, which is not specifically limited in the embodiments of this application.

The paging apparatus in the embodiments of this application may be an apparatus with an operating system. The operating system may be an Android (Android) operating system, may be an iOS operating system, or may be another possible operating system, which is not specifically limited in the embodiments of this application.

The paging apparatus provided in the embodiments of this application can implement various processes implemented by the foregoing method embodiments. To avoid repetition, details are not described herein again.

In some implementations, as shown in FIG. 5, an embodiment of this application further provides an electronic device 900, including a processor 901 and a memory 902. The memory 902 stores a program or an instruction executable on the processor 901, when the program or the instruction is executed by the processor 901, the steps of the foregoing method embodiments are implemented, and the same technical effects can be achieved. To avoid repetition, details are not described herein again.

It should be noted that, the electronic device in the embodiments of this application includes a mobile electronic device and a non-mobile electronic device.

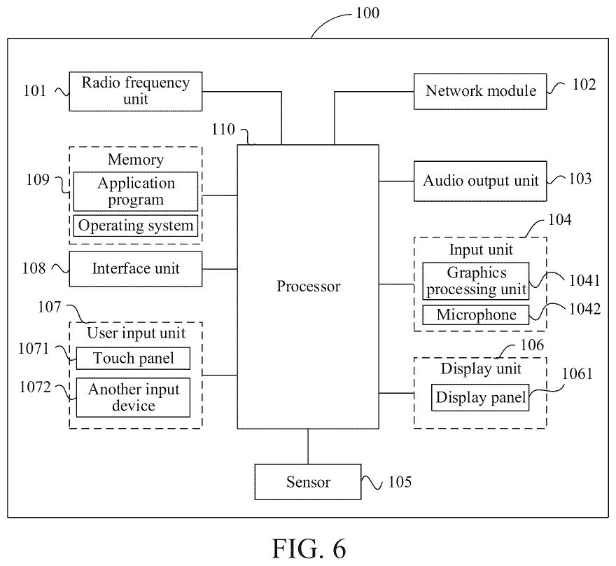

FIG. 6 is a schematic structural diagram of hardware of an electronic device according to an embodiment of this application.

The electronic device 100 includes, but is not limited to, components such as a radio frequency unit 101, a network module 102, an audio output unit 103, an input unit 104, a sensor 105, a display unit 106, a user input unit 107, an interface unit 108, a memory 109, and a processor 110.

A person skilled in the art may understand that, the electronic device 100 may further include a power supply (such as a battery) for supplying power to the components, and the power supply may be logically connected to the processor 110 by using a power management system, thereby implementing functions such as charging, discharging, and power consumption management by using the power management system. The structure of the electronic device shown in FIG. 6 constitutes no limitation to the electronic device, and the electronic device may include more or fewer components than those shown in the figure, or some components may be combined, or a different component deployment may be used.

Details are not described herein.

The processor 110 is configured to: detect whether a data radio bearer DRB that is of a first network and for transmitting IMS data has been established; in a case that the DRB that is of the first network and for transmitting the IMS data has been established, switch from the first network to a second network if incoming call information is not received within a first preset duration through the DRB that is of the first network and for transmitting the IMS data; and in a case that the DRB that is of the first network and for transmitting the IMS data has not been established, actively release the first network and send a mobility registration update request of the first network to a network side device, or perform a cell switching process, where the mobility registration update request is for requesting re-registration to the first network, the mobility registration update request includes target data, and the target data is used for indicating that an electronic device has data to be sent.

According to the electronic device provided in the embodiments of this application, the electronic device may detect whether the DRB that is of the first network and for transmitting the IMS data has been established, so that when the electronic device detects that the DRB that is of the first network and for transmitting the IMS data has been established and the incoming call information is not received within the first preset duration through the DRB that is of the first network and for transmitting the IMS data, the electronic device may determine that a current network is abnormal, and switch from the first network to the second network to receive the incoming call information. In some implementations, when the electronic device detects that the DRB that is of the first network and for transmitting the IMS data has not been established, the electronic device may actively release the first network and send the mobility registration update request of the first network to the network side device, to re-register to the first network. In addition, the mobility registration update request includes the target data indicating that the electronic device has data to be sent, so that the network side device may be induced to re-establish the DRB that is of the first network and for transmitting the IMS data to receive the incoming call information. In some implementations, when the electronic device detects that the DRB that is of the first network and for transmitting the IMS data has not been established, the electronic device may determine that the source cell in the first network is abnormal and perform a cell switching process, to receive the incoming call information through the DRB that is of the first network and for transmitting the IMS data that is established in a cell after the switching. That is, the electronic device may perform a corresponding operation through a detected establishment result of the DRB that is of the first network and for transmitting the IMS data, so that VoNR voice can be answered normally.

In some implementations, the processor 110 is specifically configured to: start a first timer, and start to detect whether the incoming call information is received through the DRB that is of the first network and for transmitting the IMS data; and switch from the first network to the second network in a case that the first timer expires and it is detected that the incoming call information is not received through the DRB that is of the first network and for transmitting the IMS data, where that the first timer expires means that a start duration of the first timer exceeds the first preset duration.

In some implementations, the processor 110 is further configured to: start a second timer, and start to detect whether the incoming call information is received through the second network after switching from the first network to the second network; and in a case that the second timer does not expire and it is detected that the incoming call information is received through the second network, answer an incoming call through the second network, and switch from the second network to the first network after the incoming call ends, where that the second timer does not expire means that a start duration of the second timer does not exceed a second preset duration; or in a case that the second timer expires and it is detected that the incoming call information is not received through the second network, switch from the second network to the first network, and re-register to a cell different from a source cell in the first network, where that the second timer expires means that a start duration of the second timer exceeds a second preset duration.

In some implementations, the radio frequency unit 101 is configured to receive a mobility registration update response sent by the network side device after the processor 110 actively releases the first network and sends the mobility registration update request of the first network to the network side device, where the mobility registration update response is used for indicating that the network side device re-establishes the DRB that is of the first network and for transmitting the IMS data, and the DRB that is of the first network and for transmitting the IMS data is used by the electronic device to receive the incoming call information.

In some implementations, the processor 110 is specifically configured to: measure signal quality of at least one neighboring cell of a source cell in the first network; switch from the source cell in the first network to a target cell in a case that a cell whose signal quality is greater than or equal to a preset threshold exists in the at least one neighboring cell, where the target cell is a cell with the greatest signal quality in the at least one neighboring cell; and receive the incoming call information through the DRB that is of the first network and for transmitting the IMS data, where the DRB that is of the first network and for transmitting the IMS data is established by the network side device in the target cell.

In some implementations, the processor 110 is specifically configured to: report a first measurement event to the network side device in a case that the target cell is an intra-frequency neighboring cell, where the first measurement event is used for indicating that the signal quality of the intra-frequency neighboring cell is greater than the signal quality of a serving cell; and receive a switching indication message sent by the network side device, and switch from the source cell in the first network to the intra-frequency neighboring cell according to the switching indication message.

In some implementations, the processor 110 is specifically configured to: report a second measurement event to the network side device in a case that the target cell is an inter-frequency neighboring cell, where the second measurement event is used for indicating that the signal quality of a serving cell is less than a preset threshold; and receive a third measurement event sent by the network side device, and switch from the source cell in the first network to the inter-frequency neighboring cell according to the third measurement event, where the third measurement event is used for indicating that the signal quality of the serving cell is less than the preset threshold and the signal quality of the inter-frequency neighboring cell is greater than the preset threshold.

The electronic device provided in the embodiments of this application can implement various processes implemented by the foregoing method embodiments, and can achieve the same technical effects. To avoid repetition, details are not described herein.

For beneficial effects of the implementations in this embodiment, reference may be made to the beneficial effects of corresponding implementations in the foregoing method embodiments. To avoid repetition, details are not described herein.

It should be understood that, in the embodiments of this application, the input unit 104 may include a Graphics Processing Unit (GPU) 1041 and a microphone 1042, and the graphics processing unit 1041 processes static pictures or video image data obtained by an image capturing device (such as a camera) in a video capturing mode or an image capturing mode. The display unit 106 may include a display panel 1061, and the display panel 1061 may be configured by using a liquid crystal display, an organic light-emitting diode, or the like. The user input unit 107 includes at least one of a touch panel 1071 and another input device 1072. The touch panel 1071 is also referred to as a touch screen. The touch panel 1071 may include two parts: a touch detection apparatus and a touch controller. The another input device 1072 may include, but not limited to, a physical keyboard, a function key (such as a volume control key or a switch key), a track ball, a mouse, and a joystick, which is not described herein.

The memory 109 may be configured to store a software program and various data. The memory 109 may mainly include a first storage area storing programs or instructions and a second storage area storing data. The first storage area may store an operating system, an application program or instruction required by at least one function (for example, a sound playback function or an image display function), and the like. In addition, the memory 109 may include a volatile memory or a non-volatile memory, or the memory 109 may include both a volatile memory and a non-volatile memory. The non-volatile memory may be a Read-Only Memory (ROM), a Programmable ROM (PROM), an Erasable PROM (EPROM), an Electrically RPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch Link DRAM (SLDRAM), and a Direct Rambus RAM (DRRAM). The memory 109 in the embodiments of this application includes, but is not limited to, these memories and any other memory of a suitable type.

The processor 110 may include one or more processing units. In some implementations, the processor 110 may integrate an application processor and a modem processor, where the application processor mainly processes operations involving an operating system, a user interface, an application program, and the like, and the modem processor mainly processes a wireless communication signal, for example, a baseband processor. It may be understood that, the modem processor may not be integrated into the processor 110.

An embodiment of this application further provides a readable storage medium, storing a program or an instruction, where when the program or the instruction is executed by a processor, the processes of the foregoing method embodiments are implemented, and the same technical effects can be achieved. To avoid repetition, details are not described herein.

The processor is a processor in the electronic device in the foregoing embodiments. The readable storage medium includes a computer-readable storage medium, for example, a computer ROM, a RAM, a magnetic disk, or an optical disc.

An embodiment of this application additionally provides a chip, including a processor and a communication interface, where the communication interface is coupled to the processor, the processor is configured to execute a program or an instruction to implement the processes of the foregoing method embodiments, and the same technical effects can be achieved. To avoid repetition, details are not described herein.

It should be understood that, the chip mentioned in the embodiments of this application may also be referred to as a system-level chip, a system chip, a chip system, a system on chip, or the like.

An embodiment of this application provides a computer program product, stored in a storage medium, where when the program product is executed by at least one processor, the processes of the foregoing method embodiments are implemented, and the same technical effects can be achieved. To avoid repetition, details are not described herein.

It should be noted that, the term “include,” “comprise,” or any other variation thereof in this specification is intended to cover non-exclusive inclusion. Therefore, a process, a method, an object, or an apparatus that includes a series of elements not only includes such elements, but also includes other elements not specified expressly, or may include inherent elements of the process, the method, the object, or the apparatus. Without more limitations, elements defined by the sentence “including one . . . does not exclude that there are still other same elements in the process, the method, the object, or the apparatus which includes the element. In addition, it should be noted that, the scopes of the method and the apparatus in the implementations of this application are not limited to performing functions according to a shown or discussed order, but may further include performing functions basically at the same time or in a reverse order according to the functions involved. For example, the described method may be performed according to an order different from the described order, and various steps may be added, omitted, or combined. In addition, features described with reference to some examples may be combined in other examples.

Through the description of the foregoing implementations, a person skilled in the art may clearly understand that the method according to the foregoing embodiments may be implemented by means of software and a necessary general hardware platform, and certainly, may alternatively be implemented by hardware. Based on such an understanding, the technical solutions of this application essentially or the part contributing to the related art may be implemented in a form of a computer software product. The computer software product is stored in a storage medium (such as a ROM/RAM, a magnetic disk, or an optical disc) and includes several instructions for instructing a terminal (which may be a mobile phone, a computer, a server, a network device, or the like) to perform the methods described in the embodiments of this application.

The embodiments of this application have been described above with reference to the accompanying drawings. This application is not limited to the specific implementations described above, and the specific implementations described above are merely exemplary and not limitative. A person of ordinary skill in the art may make various variations under the teaching of this application without departing from the spirit of this application and the protection scope of the claims, and such variations shall all fall within the protection scope of this application.

What is claimed is:

1. A paging method, comprising:
detecting whether a Data Radio Bearer (DRB) of a first network, configured for transmitting Internet Protocol (IP) Multimedia Subsystem (IMS) data, has been established;
when the DRB of the first network, configured for transmitting the IMS data, has been established, switching from the first network to a second network when incoming call information via the DRB of the first network is not received within a first preset duration; and
when the DRB of the first network, configured for transmitting the IMS data, has not been established, actively releasing the first network and sending a mobility registration update request of the first network to a network side device, or performing a cell switching process,
wherein the mobility registration update request is configured to request re-registration to the first network, the mobility registration update request comprises target data, and the target data is configured to indicate that an electronic device has data to send.

2. The method according to claim 1, wherein the switching from the first network to a second network when incoming call information via the DRB of the first network is not received within a first preset duration comprises:
starting a first timer, and starting to detect whether the incoming call information is received via the DRB of the first network; and
switching from the first network to the second network when the first timer expires and when it is detected that the incoming call information is not received via the DRB of the first network, wherein the first timer expires indicates that a start duration of the first timer exceeds the first preset duration.

3. The method according to claim 1, wherein after the switching from the first network to a second network, the method further comprises:
starting a second timer, and starting to detect whether the incoming call information is received via the second network; and
when the second timer does not expire and when it is detected that the incoming call information is received via the second network, answering an incoming call through the second network, and switching from the second network to the first network after the incoming call ends, wherein that the second timer does not expire indicates that a start duration of the second timer does not exceed a second preset duration; or
when the second timer expires and when it is detected that the incoming call information is not received via the second network, switching from the second network to the first network, and re-registering to a cell different from a source cell in the first network, wherein that the second timer expires indicates that a start duration of the second timer exceeds a second preset duration.

4. The method according to claim 1, wherein after the actively releasing the first network and sending a mobility registration update request of the first network to a network side device, the method further comprises:
receiving a mobility registration update response sent by the network side device, wherein the mobility registration update response is configured to indicate that the network side device re-establishes the DRB of the first network, and the DRB of the first network is used by the electronic device to receive the incoming call information.

5. The method according to claim 1, wherein the performing a cell switching process comprises:
measuring signal quality of at least one neighboring cell of a source cell in the first network;
switching from the source cell in the first network to a target cell when a cell whose signal quality is greater than or equal to a preset threshold exists in the at least one neighboring cell, wherein the target cell is a cell with the greatest signal quality in the at least one neighboring cell; and
receiving the incoming call information via the DRB of the first network, wherein the DRB of the first network is established by the network side device in the target cell.

6. The method according to claim 5, wherein the switching from the source cell in the first network to a target cell comprises:
reporting a first measurement event to the network side device when the target cell is an intra-frequency neighboring cell, wherein the first measurement event is configured to indicate that the signal quality of the intra-frequency neighboring cell is greater than the signal quality of a serving cell; and
receiving a switching indication message sent by the network side device, and switching from the source cell in the first network to the intra-frequency neighboring cell according to the switching indication message.

7. The method according to claim 5, wherein the switching from the source cell in the first network to a target cell comprises:
reporting a second measurement event to the network side device when the target cell is an inter-frequency neighboring cell, wherein the second measurement event is configured to indicate that the signal quality of a serving cell is less than a preset threshold; and
receiving a third measurement event sent by the network side device, and switching from the source cell in the first network to the inter-frequency neighboring cell according to the third measurement event, wherein the third measurement event is configured to indicate that the signal quality of the serving cell is less than the preset threshold and the signal quality of the inter-frequency neighboring cell is greater than the preset threshold.

8. An electronic device, comprising:
a memory storing computer-readable instructions; and
a processor coupled to the memory and configured to perform operations comprising:
detecting whether a Data Radio Bearer (DRB) of a first network, configured for transmitting Internet Protocol (IP) Multimedia Subsystem (IMS) data, has been established;
when the DRB of the first network, configured for transmitting the IMS data, has been established, switching from the first network to a second network when incoming call information via the DRB of the first network is not received within a first preset duration; and
when the DRB of the first network, configured for transmitting the IMS data has not been established, actively releasing the first network and sending a mobility registration update request of the first network to a network side device, or performing a cell switching process,
wherein the mobility registration update request is configured to request re-registration to the first network, the mobility registration update request comprises target data, and the target data is configured to indicate that an electronic device has data to send.

9. The electronic device according to claim 8, wherein the switching from the first network to a second network when incoming call information via the DRB of the first network is not received within a first preset duration comprises:
starting a first timer, and starting to detect whether the incoming call information is received via the DRB of the first network; and
switching from the first network to the second network when the first timer expires and when it is detected that the incoming call information is not received via the DRB of the first network, wherein the first timer expires indicates that a start duration of the first timer exceeds the first preset duration.

10. The electronic device according to claim 8, wherein after the switching from the first network to a second network, the operations further comprise:
starting a second timer, and starting to detect whether the incoming call information is received via the second network; and
when the second timer does not expire and when it is detected that the incoming call information is received via the second network, answering an incoming call through the second network, and switching from the second network to the first network after the incoming call ends, wherein that the second timer does not expire indicates that a start duration of the second timer does not exceed a second preset duration; or
when the second timer expires and when it is detected that the incoming call information is not received via the second network, switching from the second network to the first network, and re-registering to a cell different from a source cell in the first network, wherein that the second timer expires indicates that a start duration of the second timer exceeds a second preset duration.

11. The electronic device according to claim 8, wherein after the actively releasing the first network and sending a mobility registration update request of the first network to a network side device, the operations further comprise:
receiving a mobility registration update response sent by the network side device, wherein the mobility registration update response is configured to indicate that the network side device re-establishes the DRB of the first network, and the DRB of the first network is used by the electronic device to receive the incoming call information.

12. The electronic device according to claim 8, wherein the performing a cell switching process comprises:
measuring signal quality of at least one neighboring cell of a source cell in the first network;
switching from the source cell in the first network to a target cell when a cell whose signal quality is greater than or equal to a preset threshold exists in the at least one neighboring cell, wherein the target cell is a cell with the greatest signal quality in the at least one neighboring cell; and
receiving the incoming call information via the DRB of the first network, wherein the DRB of the first network is established by the network side device in the target cell.

13. The electronic device according to claim 12, wherein the switching from the source cell in the first network to a target cell comprises:
reporting a first measurement event to the network side device when the target cell is an intra-frequency neighboring cell, wherein the first measurement event is configured to indicate that the signal quality of the intra-frequency neighboring cell is greater than the signal quality of a serving cell; and
receiving a switching indication message sent by the network side device, and switching from the source cell in the first network to the intra-frequency neighboring cell according to the switching indication message.

14. The electronic device according to claim 12, wherein the switching from the source cell in the first network to a target cell comprises:
reporting a second measurement event to the network side device when the target cell is an inter-frequency neighboring cell, wherein the second measurement event is configured to indicate that the signal quality of a serving cell is less than a preset threshold; and
receiving a third measurement event sent by the network side device, and switching from the source cell in the first network to the inter-frequency neighboring cell according to the third measurement event, wherein the third measurement event is configured to indicate that the signal quality of the serving cell is less than the preset threshold and the signal quality of the inter-frequency neighboring cell is greater than the preset threshold.

15. A non-transitory computer-readable medium storing instructions that, when executed by a processor, cause the processor to perform operations comprising:
detecting whether a Data Radio Bearer (DRB) of a first network, configured for transmitting Internet Protocol (IP) Multimedia Subsystem (IMS) data, has been established;
when the DRB of the first network, configured for transmitting the IMS data, has been established, switching from the first network to a second network when incoming call information via the DRB of the first network is not received within a first preset duration; and
when the DRB of the first network, configured for transmitting the IMS data has not been established, actively releasing the first network and sending a mobility registration update request of the first network to a network side device, or performing a cell switching process,
wherein the mobility registration update request is configured to request re-registration to the first network, the mobility registration update request comprises target data, and the target data is configured to indicate that an electronic device has data to send.

16. The non-transitory computer-readable medium according to claim 15, wherein the switching from the first network to a second network when incoming call information via the DRB of the first network is not received within a first preset duration comprises:
starting a first timer, and starting to detect whether the incoming call information is received via the DRB of the first network; and
switching from the first network to the second network when the first timer expires and when it is detected that the incoming call information is not received via the DRB of the first network, wherein the first timer expires indicates that a start duration of the first timer exceeds the first preset duration.

17. The non-transitory computer-readable medium according to claim 15, wherein after the switching from the first network to a second network, the operations further comprise:
starting a second timer, and starting to detect whether the incoming call information is received via the second network; and
when the second timer does not expire and when it is detected that the incoming call information is received via the second network, answering an incoming call through the second network, and switching from the second network to the first network after the incoming call ends, wherein that the second timer does not expire indicates that a start duration of the second timer does not exceed a second preset duration; or
when the second timer expires and when it is detected that the incoming call information is not received via the second network, switching from the second network to the first network, and re-registering to a cell different from a source cell in the first network, wherein that the second timer expires indicates that a start duration of the second timer exceeds a second preset duration.

18. The non-transitory computer-readable medium according to claim 15, wherein after the actively releasing the first network and sending a mobility registration update request of the first network to a network side device, the operations further comprise:
receiving a mobility registration update response sent by the network side device, wherein the mobility registration update response is configured to indicate that the network side device re-establishes the DRB of the first network, and the DRB of the first network is used by the electronic device to receive the incoming call information.

19. The non-transitory computer-readable medium according to claim 15, wherein the performing a cell switching process comprises:
measuring signal quality of at least one neighboring cell of a source cell in the first network;
switching from the source cell in the first network to a target cell when a cell whose signal quality is greater than or equal to a preset threshold exists in the at least one neighboring cell, wherein the target cell is a cell with the greatest signal quality in the at least one neighboring cell; and
receiving the incoming call information via the DRB of the first network, wherein the DRB of the first network is established by the network side device in the target cell.

20. The non-transitory computer-readable medium according to claim 19, wherein the switching from the source cell in the first network to a target cell comprises:
reporting a first measurement event to the network side device when the target cell is an intra-frequency neighboring cell, wherein the first measurement event is configured to indicate that the signal quality of the intra-frequency neighboring cell is greater than the signal quality of a serving cell; and
receiving a switching indication message sent by the network side device, and switching from the source cell in the first network to the intra-frequency neighboring cell according to the switching indication message.
